(19) United States
(12) Patent Application Publication
(10) Pub. No.: US 2013/0105712 A1
(43) Pub. Date: May 2, 2013

(54) APPARATUS AND METHOD FOR GENERATING EXTREME ULTRAVIOLET LIGHT

(71) Applicants: Tatsuya Yanagida, Hiratsuka-shi (JP); Junichi Fujimoto, Oyama-shi (JP); Osamu Wakabayashi, Hiratsuka-shi (JP)

(72) Inventors: Tatsuya Yanagida, Hiratsuka-shi (JP); Junichi Fujimoto, Oyama-shi (JP); Osamu Wakabayashi, Hiratsuka-shi (JP)

(73) Assignee: GIGAPHOTON INC., Oyama-shi, Tochigi (JP)

(21) Appl. No.: 13/805,278

(22) PCT Filed: Feb. 21, 2012
(86) PCT No.: PCT/IB12/00319

§ 371 Date: Dec. 18, 2012

(30) Foreign Application Priority Data
Mar. 23, 2011 (JP) 2011-064060
Jun. 15, 2011 (JP) 2011-133113

(51) Int. Cl. H05G 2/00

(52) U.S. Cl. CPC H05G 2/003
USPC 250/504 R

(57) ABSTRACT

A method for generating extreme ultraviolet (EUV) light that includes the steps of supplying a droplet of a target material into a chamber, diffusing the droplet by irradiating the droplet by a pre-pulse laser beam to form a diffused target, and generating a plasma by irradiating the diffused target by a main pulse laser beam wherein the plasma emits extreme ultraviolet light. The main pulse laser beam has a cross-sectional shape that is substantially coincident with a shape of the diffused target at the irradiation point.

### CROSS-REFERENCE TO RELATED APPLICATIONS

The present application claims priority from Japanese Patent Application No. 2011-064060, filed Mar. 23, 2011, and Japanese Patent Application No. 2011-133113, filed Jun. 15, 2011.

### BACKGROUND

1. Technical Field

This disclosure relates to an apparatus and a method for generating extreme ultraviolet (EUV) light.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used.

### SUMMARY

A method for generating extreme ultraviolet light according to one aspect of this disclosure may include: (a) supplying a droplet of a target material at an irradiation point; (b) diffusing the droplet by irradiating the droplet by a pre-pulse laser beam to form a diffused target; and (c) generating plasma by irradiating the diffused target by a main pulse laser beam and generating extreme ultraviolet light from the plasma. A cross-sectional shape of the main pulse laser beam perpendicular to a beam axis of the main pulse laser beam may substantially coincide with a cross-sectional shape of the diffused target perpendicular to the beam axis of the main pulse laser beam at the irradiation point.

A method for generating extreme ultraviolet light according to another aspect of this disclosure may include the steps of: (a) supplying a droplet of a target material into a chamber; (b) irradiating the target material by a pre-pulse laser beam; and (c) generating plasma by irradiating the target material irradiated by the pre-pulse laser beam by a main pulse laser beam and generating extreme ultraviolet light from the plasma. The main pulse laser beam may have, at an irradiation point of the chamber, a low beam intensity region in a central area thereof extending over a predetermined distance from a beam axis of the main pulse laser beam. The low beam intensity region may have a first beam intensity that is lower than a second beam intensity in a peripheral area surrounding the central area.

An apparatus for generating EUV light according to still another aspect of this disclosure may include: a chamber comprising an irradiation point; a droplet generator configured to supply droplets of a target material to the irradiation point; and at least one optical element configured to introduce into the chamber a pre-pulse laser beam for irradiating the target material and a main pulse laser beam for generating plasma by irradiating the target material irradiated by the pre-pulse laser beam. The pre-pulse laser beam may comprise a beam intensity and a fluence. The main pulse laser beam may comprise a propagation path, a beam axis, a wavefront curvature, and a beam intensity distribution. The apparatus may also include a beam intensity distribution adjusting optical system that is disposed in the laser beam propagation path of the main pulse laser beam. The beam intensity distribution adjusting optical system may be configured to adjust the beam intensity distribution of the main pulse laser beam at the irradiation point such that a low beam intensity region extends radially outward around the beam axis of the main pulse laser beam over a predetermined distance and a peripheral region surrounds the low beam intensity region, the low beam intensity region having a first beam intensity and the peripheral region having a second beam intensity that is higher than the first beam intensity.

### BRIEF DESCRIPTION OF THE DRAWINGS

Embodiments of this disclosure will now be described with reference to the accompanying drawings.

FIG. 1 schematically shows an exemplary LPP-type EUV light generation system.

FIG. 2 schematically shows another embodiment of an LPP-type EUV light generation system according to the embodiments of this disclosure.

FIG. 3A is a conceptual diagram illustrating a droplet being irradiated by a pre-pulse laser beam.

FIGS. 3B and 3C are conceptual diagrams illustrating irradiation of a torus-shaped diffused target by a main pulse laser beam.

FIG. 4 shows photographs of molten tin droplets being irradiated by pre-pulse laser beams.

FIG. 5 shows photographs of molten tin droplets being irradiated by pre-pulse laser beams.

FIG. 6 is a conceptual diagram illustrating a first embodiment of the beam intensity distribution adjusting optical system.

FIG. 7 is a conceptual diagram illustrating a second embodiment of the beam intensity distribution adjusting optical system.

FIG. 8A is a conceptual diagram illustrating a third embodiment of the beam intensity distribution adjusting optical system, and FIG. 8B shows a surface on which a diffraction grating is formed.

FIG. 8C is an enlarged sectional view of the diffraction grating.

FIG. 9 is a conceptual diagram illustrating a fourth embodiment of the beam intensity distribution adjusting optical system.

FIG. 10 is a conceptual diagram illustrating a fifth embodiment of the beam intensity distribution adjusting optical system.

FIG. 11A is a conceptual diagram illustrating a sixth embodiment of the beam intensity distribution adjusting optical system, and FIG. 11B shows a surface of the diffraction element on which a diffraction grating is formed.

FIG. 11C is an enlarged sectional view of the diffraction grating.

FIG. 12 is a conceptual diagram illustrating a seventh embodiment of the beam intensity distribution adjusting optical system.

### DESCRIPTION OF PREFERRED EMBODIMENTS

Hereinafter, embodiments of this disclosure will be described in detail with reference to the accompanying drawings. The embodiments described below are merely illustrative in nature and do not limit the scope of this disclosure. Further, the configurations and operations described in connection with each embodiment are not necessarily essential in implementation of the configurations and operations in this disclosure. Like elements are referenced by like reference numbers and symbols, and duplicate descriptions thereof will be omitted herein.

### Contents

### 1. Overview

### 2. Explanation of Terms

### 3. General Description of EUV Light Generation System

### 3.1 Configuration

### 3.2 Operation

4. LPP-Type EUV Light Generation System with Beam Intensity Distribution Adjusting Optical System

### 4.1 Configuration

### 4.2 Operation

### 5. Torus-Shaped Diffused Target

### 5.1 Irradiation by Pre-Pulse Laser Beam

### 5.2 Irradiation by Main Pulse Laser Beam

### 6. Embodiments of Beam Intensity Distribution Adjusting Optical System

### 6.1 Scheme for Generating Annular Laser Beam and Focusing Annular Laser Beam by Focusing Optical System

### 6.1.1 Generation of Annular Laser Beam by Axicon Lens

### 6.1.2 Generation of Annular Laser Beam by Axicon Mirror

### 6.1.3 Generation of Annular Laser Beam by Concentric Diffraction Grating

6.2 Scheme for Refracting or Reflecting Laser Beam Symmetrically with Respect to Optical Axis and Forming Focus by Focusing Optical System
6.2.1 Combination of Axicon Lens with Focusing Optical System
6.2.2 Combination of Axicon Mirror with Focusing Optical System
6.2.3 First Combination of Concentric Diffraction Grating with Focusing Optical System
6.2.4 Second Combination of Concentric Diffraction Grating with Focusing Optical System

### 1. Overview

In certain embodiments of this disclosure, a droplet of a target material, also referred to herein as a target, may be supplied into a chamber. The droplet may be irradiated by a pre-pulse laser beam, thereby diffusing the droplet and forming a torus-shaped diffused target. Subsequently, the torus-shaped diffused target may be irradiated by a main pulse laser beam having a lower beam intensity in the central area of its cross-section than in the peripheral area. The diffused target may be turned into plasma that emits EUV light. In certain embodiments of this disclosure, the laser beam can efficiently be absorbed into the target material and the laser beam energy can be converted into the EUV light energy with a high conversion efficiency (CE).

### 2. Explanation of Terms

Terms used herein may be interpreted as follows. The term “pre-pulse laser beam” may refer to a laser beam for forming a desired diffused target by diffusing a droplet of a target material. The term “main pulse laser beam” may refer to a laser beam for generating plasma by exciting the diffused target. The term “debris” may refer to particles that may cause contamination or damage to an optical element, such as an EUV collector mirror. The debris may include neutral particles of the target material supplied into a chamber but not turned into plasma as well as charged particles emitted from the plasma.

### 3. General Description of EUV Light Generation System

### 3.1 Configuration

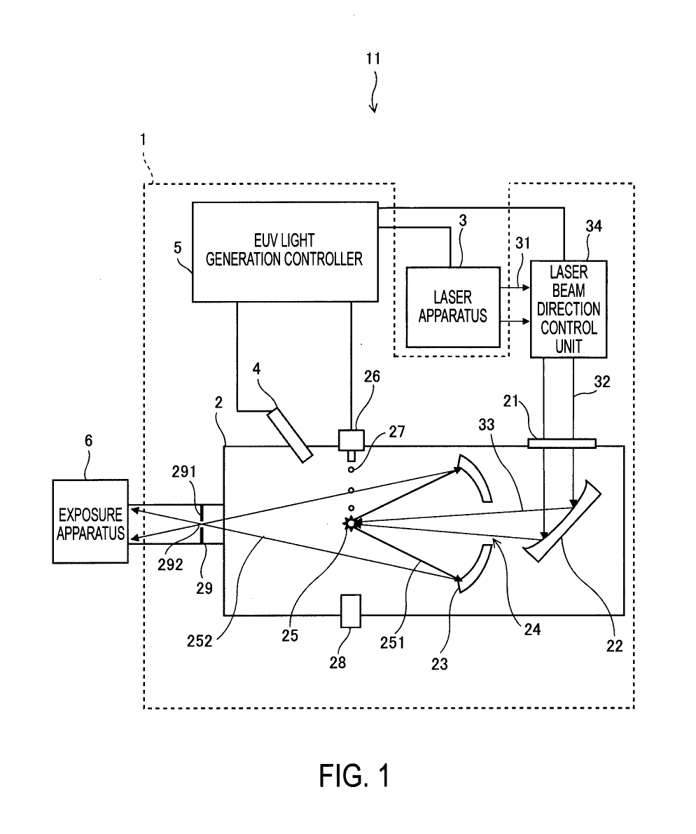

FIG. 1 schematically illustrates an exemplary LPP type EUV light generation system. An EUV light generation apparatus 1 may be used with at least one laser apparatus 3. In this example, a system including the EUV light generation apparatus 1 and the laser apparatus 3 may be referred to as an EUV light generation system 11. As illustrated in FIG. 1 and described in detail below, the EUV light generation apparatus 1 may include a chamber 2 and a target supply unit (e.g., droplet generator 26). The chamber 2 may be airtightly sealed. The droplet generator 26 may be mounted to the chamber 2 so as to pass through the wall of the chamber 2. The droplet generator 26 may be configured to supply one or more targets 27, alternately and equivalently referred to herein as “target droplets” and “droplets,” comprising a target material that may comprise one or more of the group of tin, terbium, gadolinium, lithium, and xenon, or any combination, alloy, or mixture thereof.

The chamber 2 may comprise at least one through-hole formed in the wall thereof. The through-hole may be covered with a window 21, and a pulsed laser beam 32 may travel through the window 21 into the chamber 2. An EUV collector mirror 23 having a spheroidal surface may be disposed inside the chamber 2. The EUV collector mirror 23 may comprise a multi-layered reflective film formed on the spheroidal surface thereof. The reflective film can include molybdenum and silicon that are, for example, laminated in alternate layers. The EUV collector mirror 23 may have first and second foci. The EUV collector mirror 23 may preferably be disposed such that the first focus thereof lies in a plasma generation region 25 and the second focus thereof lies in an intermediate focus (IF) region 292 defined by the specification of an exposure apparatus. The EUV collector mirror 23 may have a through-hole 24 formed at the center thereof, and a pulsed laser beam 33 may travel through the through-hole 24.

The EUV light generation system 11 may include an EUV light generation controller 5. The EUV light generation apparatus 1 may also include a target sensor 4 that may have an imaging function and may detect at least one of the presence, trajectory, and position of a target.

The EUV light generation apparatus 1 may include a connection part 29 for allowing the interior of the chamber 2 and the interior of the exposure apparatus 6 to be in communication with each other. A wall 291 having an aperture may be disposed inside the connection part 29 such that the second focus of the EUV collector mirror 23 lies in the aperture formed in the wall 291.

The EUV light generation system 1 may include a laser beam direction control unit 34, a laser beam focusing mirror 22, and a target collection unit 28 for collecting a target 27. The laser beam direction control unit 34 may include an optical element (not visible in FIG. 1) for defining the direction in which the laser beam 32 travels and an actuator for adjusting the position and the orientation (or posture) of the optical element.

### 3.2 Operation

With reference to FIG. 1, a pulsed laser beam 31 outputted from the laser apparatus 3 may pass through the laser beam direction control unit 34, and may be outputted from the laser beam direction control unit 34 as a pulsed laser beam 32 after having its direction optionally adjusted. The pulsed laser beam 32 may travel through the window 21, and enter the chamber 2. The pulsed laser beam 32 may travel inside the chamber 2 along at least one beam path from the laser apparatus 3, be reflected by the laser beam focusing mirror 22, and strike at least one target 27 as a pulsed laser beam 33.

The droplet generator 26 may output the targets 27 toward the plasma generation region 25 inside the chamber 2. When the target 27 reaches the plasma generation region 25, the droplet 27 may be irradiated by at least one pulse of the pulsed laser beam 33 and thereby turned into plasma that emits rays of light including EUV light 251. The EUV light 251 may be reflected selectively by the EUV collector mirror 23. EUV light 252 reflected by the EUV collector mirror 23 may travel through the intermediate focus region 292 and be outputted to the exposure apparatus 6. In certain embodiments, the target 27 may be irradiated by multiple pulses of the pulsed laser beam 33.

The EUV light generation controller 5 may control the EUV light generation system 11. The EUV light generation controller 5 may process image data of the droplet 27 captured by the target sensor 4. Further, the EUV light generation controller 5 may control at least one of the timing at which the target 27 is outputted and the direction at which the droplet 27 is outputted (e.g., the timing at which and/or direction in which the droplet 27 is supplied by the droplet generator 26). Furthermore, the EUV light generation controller 5 may control at least one of the timing with which the laser apparatus 3 oscillates (e.g., by controlling laser apparatus 3), the direction in which the pulsed laser beam 31 travels (e.g., by controlling laser beam direction control unit 34), and the position at which the pulsed laser beam 33 is focused (e.g., by controlling laser apparatus 3, laser beam direction control unit 34, or the like), for example. The various controls mentioned above are merely examples, and other controls may be added as necessary.

4. LPP-Type EUV Light Generation System with Beam Intensity Distribution Adjusting Optical System

### 4.1 Configuration

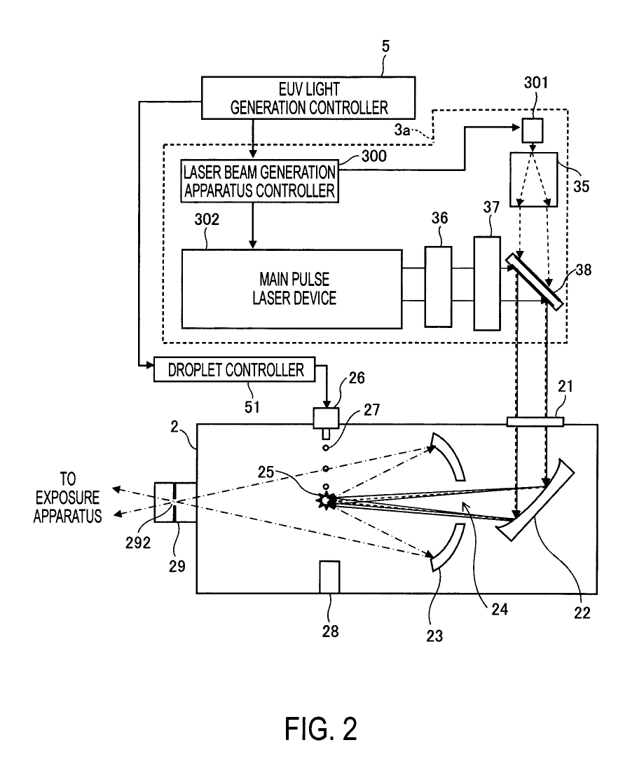

FIG. 2 schematically shows another embodiment of an LPP-type EUV light generation system according to certain aspects of the present disclosure. In FIG. 2, the laser apparatus 3 of FIG. 1 may be replaced by a laser beam generation apparatus 3a that includes a pre-pulse laser device 301 and a main pulse laser device 302. The laser beam generation apparatus 3a may also include a laser beam generation apparatus controller 300, a beam expander 35, a wavefront adjusting optical system 36, a laser beam adjusting optical system 37, and a beam combiner 38. The LPP-type EUV light generation system shown in FIG. 2 may include a droplet controller 51.

The beam combiner 38 may be disposed at an intersection of a laser beam propagation path of the pre-pulse laser beam from the pre-pulse laser device 301 with a laser beam propagation path of the main pulse laser beam from the main pulse laser device 302. The beam combiner 38 may be an optical element configured to transmit the light at a first wavelength contained in the pre-pulse laser beam and reflect the light at a second wavelength contained in the main pulse laser beam with high reflectivity.

The laser beam adjusting optical system 37 may be disposed in the laser beam propagation path between the main pulse laser device 302 and the beam combiner 38. A beam intensity distribution adjusting optical system may include the laser beam adjusting optical system 37 and the laser beam focusing mirror 22. The laser beam adjusting optical system 37 may be configured to adjust the beam intensity distribution of the main pulse laser beam such that the main pulse laser beam has an annular cross-section. Alternatively, the laser beam adjusting optical system 37 may comprise an optical system for adjusting the main pulse laser beam by refracting or reflecting the main pulse laser beam at a predetermined angle symmetrically about its optical axis such that the main pulse laser beam is focused to form an annular focal point. In certain aspects, at the point of irradiation of the target 27, the main pulse laser beam may have a lower beam intensity in its central area than in its peripheral area. The main pulse laser beam output from the laser beam adjusting optical system 37 may be focused by a focusing optical system, such as the laser beam focusing mirror 22, onto the target 27 at the plasma generation region 25.

The wavefront adjusting optical system 36 may be disposed in the main pulse laser beam propagation path between the main pulse laser device 302 and the beam combiner 38. The wavefront adjusting optical system 36 may comprise an optical element for adjusting the focus of the main pulse laser beam by adjusting the wavefront curvature of the main pulse laser beam, for example when the pre-pulse laser beam and the main pulse laser beam reflected by the laser beam focusing mirror 22 are not focused at a predetermined focus. The wavefront adjusting optical system 36 may include a combination of a planoconvex lens and a planoconcave lens, wherein the wavefront curvature of the main pulse laser beam transmitted through the wavefront adjusting optical system 36 may be adjusted by adjusting the distance between the planoconvex lens and the planoconcave lens.

The beam expander 35 may be disposed in the laser beam propagation path between the pre-pulse laser device 301 and the beam combiner 38. The wavefront adjusting optical system 36 and the laser beam adjusting optical system 37 may be disposed on the laser beam propagation path inside the main pulse laser device 302.

### 4.2 Operation

With respect to the exemplary embodiment of FIG. 2, the droplet controller 51 may receive a droplet generation trigger signal from the EUV light generation controller 5 and output a drive signal to the droplet generator 26 to cause the droplet generator 26 to output a droplet 27.

The laser beam generation apparatus controller 300 may receive a laser beam generation trigger signal from the EUV light generation controller 5 and output a pre-pulse laser oscillation trigger signal and a pre-pulse laser beam intensity setting signal to the pre-pulse laser device 301. The pre-pulse laser oscillation trigger signal may be output such that the droplet 27 is irradiated by the pre-pulse laser beam when the droplet 27 reaches the plasma generation region 25. The pre-pulse laser beam intensity setting signal may be output such that the droplet 27 is irradiated by a pre-pulse laser beam with a beam intensity suitable for diffusing the droplet 27 to form a desired diffused target. Alternatively, the laser beam generation apparatus controller 300 may output a pre-pulse laser beam fluence setting signal, instead of the pre-pulse laser beam intensity setting signal, to the pre-pulse laser device 301. The fluence is the energy per unit cross-sectional area of the laser beam at the focus.

The laser beam generation apparatus controller 300 may also output a main pulse laser oscillation trigger signal and a main pulse laser beam intensity setting signal to the main pulse laser device 302. The main pulse laser oscillation trigger signal may be output such that the main pulse laser beam is output with a delay after the droplet 27 is irradiated by the pre-pulse laser beam to allow the desired diffused target to be formed. The main pulse laser beam intensity setting signal may be output such that the diffused target is irradiated by the main pulse laser beam with beam intensity for exciting the diffused target and turning the diffused target into plasma.

The pre-pulse laser device 301 may output the pre-pulse laser beam on the basis of the pre-pulse laser oscillation trigger signal and the pre-pulse laser beam intensity setting signal output from the laser beam generation apparatus controller 300. The pre-pulse laser beam may be expanded in diameter by the beam expander 35 before entering the beam combiner 38.

The main pulse laser device 302 may output the main pulse laser beam on the basis of the main pulse laser oscillation trigger signal and the main pulse laser beam intensity setting signal output from the laser beam generation apparatus controller 300. The main pulse laser beam may enter the beam combiner 38 through the wavefront adjusting optical system 36 and the laser beam adjusting optical system 37. The beam combiner 38 may introduce the main pulse laser beam and the pre-pulse laser beam into the chamber 2 along substantially the same path.

### 5. Torus-Shaped Diffused Target

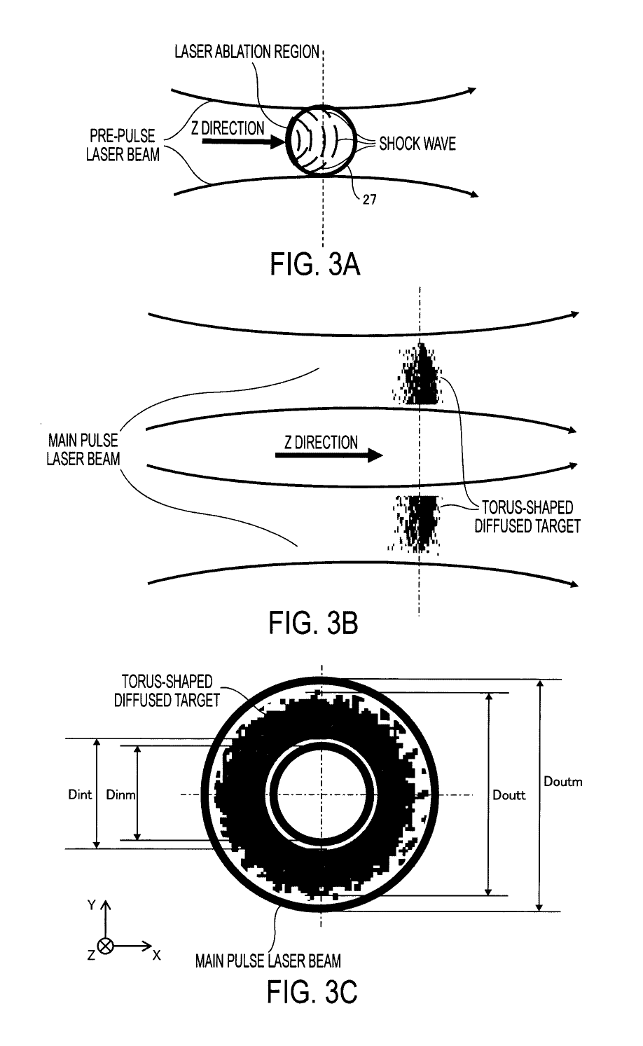

FIG. 3A is a conceptual diagram illustrating a droplet 27 being irradiated by a pre-pulse laser beam. FIGS. 3B and 3C are conceptual diagrams illustrating irradiation of a torus-shaped diffused target by a main pulse laser beam. The torus-shaped diffused target may be formed from the droplet irradiated by the pre-pulse laser beam. FIGS. 3A and 3B show the droplet and the diffused target as viewed in the direction perpendicular to the respective beam axes, i.e. perpendicular to the Z directions shown in FIGS. 3A and 3B, of the pre-pulse laser beam and the main pulse laser beam. FIG. 3C is a cross-sectional view along a plane perpendicular to the z direction, i.e., the beam axis of the main pulse laser beam.

### 5.1 Irradiation by Pre-Pulse Laser Beam

The diffusion of a droplet 27 irradiated by a pre-pulse laser beam will now be described. As shown in FIG. 3A, when the pre-pulse laser beam is focused onto the droplet 27, laser ablation may occur near the surface of the droplet 27. Consequently, due to a reaction pressure caused by the laser ablation, a shock wave may propagate from the surface toward the interior of the droplet 27. This shock wave may gradually propagate throughout the droplet 27. This shock wave may break up and diffuse the droplet 27 when the beam intensity of the pre-pulse laser beam is equal to or greater than a first predetermined value, e.g. 1×10⁹ W/cm².

When the beam intensity of the pre-pulse laser beam is equal to or greater than a second predetermined value (e.g., 6.4×10⁹ W/cm²), the droplet 27 may be broken up and a torus-shaped diffused target may be formed, as shown in FIGS. 3B and 3C, which is substantially symmetrical about the beam axis of the pre-pulse laser beam.

In certain embodiments, a torus-shaped diffused target may be formed when the pre-pulse laser beam has a beam intensity of at least 6.4×10⁹ W/cm² and at most 3.2×10¹⁰ W/cm² and the diameter of the droplet 27 is at least 12 μm and at most 40 μm.

In certain embodiments, the pre-pulse laser beam may be controlled in terms of fluence instead of beam intensity. Controlling the fluence of the pre-pulse laser beam may allow the diffused state of the target material to be controlled.

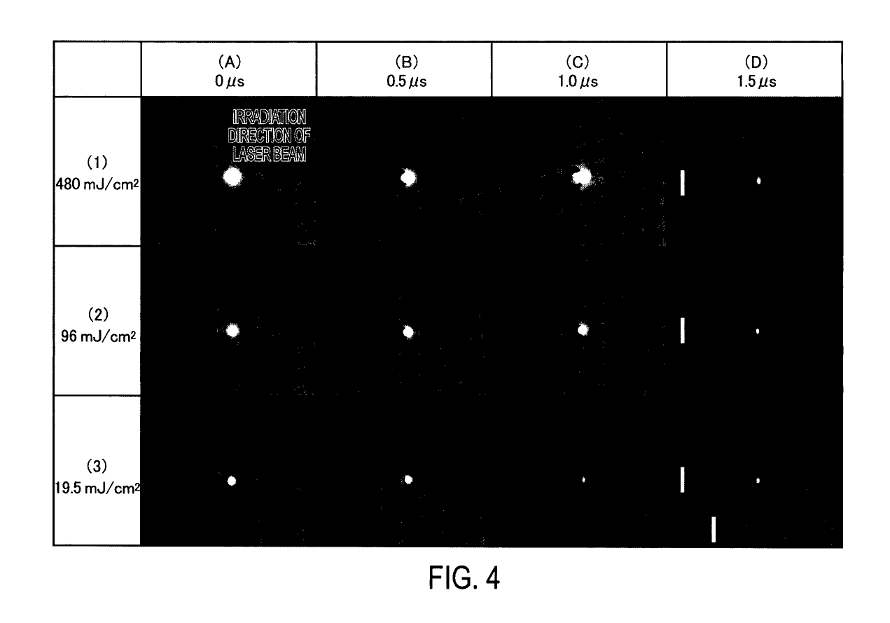

FIG. 4 shows photographs of molten tin droplets being irradiated by pre-pulse laser beams. The photographs in FIG. 4 show droplets 27 as viewed at an angle of 30 degrees with respect to the beam axis of the pre-pulse laser beam. The droplets had a diameter of 20 μm, and a pre-pulse laser beam having a pulse duration of 5 ns output from a yttrium aluminium garnet (YAG) laser was used. In the photographs in FIG. 4, the white areas are afterimages of the pre-pulse laser beam and the black areas are diffused target material.

Row (1) in FIG. 4 chronologically shows in columns (A) through (D) the diffusion of a droplet caused by a pre-pulse laser beam with a fluence of 480 mJ/cm². As shown in the photograph in row (1), column (C), the droplet was diffused in the form of a torus 1.0 μs after being irradiated by the pre-pulse laser beam.

Row (2) in FIG. 4 chronologically shows the diffusion of a droplet irradiated by a pre-pulse laser beam with a fluence of 96 mJ/cm². As shown in the photograph in row (2), column (D), the droplet was diffused in the form of a disc or a dish 1.5 μs after being irradiated by the pre-pulse laser beam.

Row (3) in FIG. 4 chronologically shows the diffusion of a droplet irradiated by a pre-pulse laser beam with a fluence of 19.5 mJ/cm². As shown in the photograph in row (3), column (D), the droplet was diffused in the form of a disc or a dish 1.5 μs after being irradiated by the pre-pulse laser beam.

As shown in the examples in FIG. 4, a diffused target is generated when the fluence of the pre-pulse laser beam is in the range of approximately 20 to 500 mJ/cm². As can be seen from the photographs, there is a tendency that a lower fluence diffuses the droplet in the form of a disc or a dish and a higher fluence diffuses the droplet in the form of a torus. Thus, controlling the fluence of the pre-pulse laser beam may allow the diffused state of the droplet to be controlled.

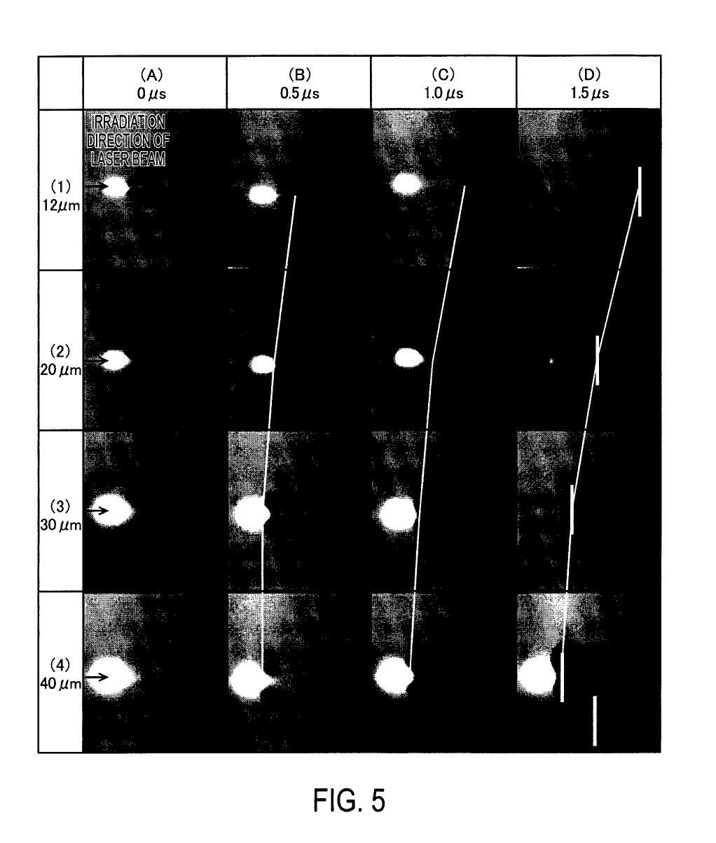

FIG. 5 shows photographs of molten tin droplets being irradiated by a pre-pulse laser beam. The photographs in FIG. 5 show droplets as viewed at an angle of 120 degrees with respect to the beam axis of the pre-pulse laser beam. A laser beam output from a YAG laser with a pulse duration of 5 ns and a fluence of 480 mJ/cm² was used as the pre-pulse laser beam. In the photographs in FIG. 5, the white areas are afterimages of the pre-pulse laser beam and the black areas are the diffused droplets.

Row (1) in FIG. 5 chronologically shows in columns (A) through (D) the diffusion of a droplet of 12 μm in diameter. As shown in the photograph in row (1), column (B), the droplet was diffused in the form of a torus 0.5 μs after being irradiated by the pre-pulse laser beam. As shown in the photographs in row (1), columns (C) and (D), the droplet was diffused nearly up to the right edge of the photograph in 1.5 μs after being irradiated by the pre-pulse laser beam.

Row (2) in FIG. 5 chronologically shows the diffusion of a droplet of 20 μm in diameter. As shown in the photograph in row (2), column (C), the droplet was diffused in the form of a torus 1.0 μs after being irradiated by the pre-pulse laser beam. As shown in the photograph in row (2), column (D), the droplet was diffused to the right half area of the photograph 1.5 μs after being irradiated by the pre-pulse laser beam.

Row (3) in FIG. 5 chronologically shows the diffusion of a droplet of 30 μm in diameter. As shown in the photograph in row (3), column (C), the droplet was diffused in the form of a torus 1.0 μs after being irradiated with the pre-pulse laser beam. As shown in the photograph in row (3), column (D), the droplet was diffused in the left half area of the photograph 1.5 μs after being irradiated by the pre-pulse laser beam.

Row (4) in FIG. 5 chronologically shows the diffusion of a droplet of 40 μm in diameter. As shown in the photograph in row (4), column (D), the droplet was diffused in the form of a torus in the left half area of the photograph 1.5 μs after being irradiated by the pre-pulse laser beam.

As observed in the photographs in column (D), for example, the droplets with smaller diameters were diffused more rightward (diffusing direction of the droplets) in the photographs. More specifically, in the range of droplet diameters of at least 12 μm and at most 40 μm, the droplets with larger diameters tend to be diffused at lower speeds and those with smaller diameters tend to be diffused at higher speeds. Thus, it has been found that the time required to reach a desired diffused state depends on the droplet diameter. This suggests that the range of optimum delay before irradiating the droplets by the main pulse laser beam depends on the droplet diameter.

### 5.2 Irradiation by Main Pulse Laser Beam

Irradiation of the torus-shaped diffused target by the main pulse laser beam will now be described. The torus-shaped diffused target may, for example, be formed 0.5 to 2.0 μs after the droplet 27 is irradiated by the pre-pulse laser beam. Accordingly, the diffused target may preferably be irradiated by the main pulse laser beam with the above delay after the droplet 27 is irradiated by the pre-pulse laser beam. As shown in FIG. 5, however, the optimum range of delay time from the irradiation by the pre-pulse laser beam to the irradiation by the main pulse laser beam may depend on the droplet diameter.

For an example droplet that is 12 μm in diameter, the delay time from the irradiation by the pre-pulse laser beam to the irradiation by the main pulse laser beam may preferably be in the range of 0.5 to 1.0 μs.

For an example droplet that is 20 μm in diameter, the delay time from the irradiation by the pre-pulse laser beam to the irradiation by the main pulse laser beam may preferably be in the range of 0.5 to 1.5 μs.

For an example droplet that is 30 μm in diameter, the delay time from the irradiation by the pre-pulse laser beam to the irradiation by the main pulse laser beam may preferably be in the range of 1.0 to 1.5 μs.

For an example target that is 40 μm in diameter, the delay time from the irradiation by the pre-pulse laser beam to the irradiation by the main pulse laser beam may preferably be in the range of 1.5 to 2.0 μs.

In certain embodiments, controlling the delay time from the irradiation by the pre-pulse laser beam to the irradiation by the main pulse laser beam into the range as described above may allow the droplet of the target material to be diffused into sufficiently fine particles. In certain embodiments, increasing the total surface area of the target material by diffusing the droplet may allow the energy of the main pulse laser beam to be absorbed efficiently into the diffused particles and the CE may be improved.

The diffused target formed by the droplet being irradiated by the pre-pulse laser beam has a shape that is shorter in length in the direction of the beam axis of the pre-pulse laser beam than in the direction perpendicular to the beam axis and the diffused target may preferably be irradiated by the main pulse laser beam approximately in the same direction as the pre-pulse laser beam. This may allow the diffused target to be irradiated by the main pulse laser beam at a high energy density and the main pulse laser beam to be absorbed efficiently into the target material with a consequent improvement in the CE in the LPP-type EUV light generation system.

Preferably, the beam intensity distribution in the cross-section of the main pulse laser beam includes a low intensity region extending over its central area where the beam intensity is lower than in a peripheral region surrounding the low beam intensity region. With this beam intensity distribution, the plasma is confined in a cylindrical region with a low beam intensity surrounded by a peripheral beam path with a higher beam intensity thereby generating plasma at a high temperature and a high density with an improved CE. Furthermore, when the diffused target is torus-shaped, the cross-sectional shape of the main pulse laser beam perpendicular to the beam axis thereof may be adapted to the shape of the diffused target. This may reduce the proportion of the laser beam that passes through the center of the torus-shaped diffused target, which contributes less to the generation of EUV light. Accordingly, more of the energy of the main pulse laser beam may be utilized to convert the diffused target into plasma, resulting in a higher CE.

Preferably, the beam intensity of the main pulse laser beam is distributed in an annular shape in the direction perpendicular to the beam axis of the laser beam such that an outer diameter Dₒᵤₜₘ and an inner diameter Dᵢₙₘ of the main pulse laser beam are in the following relationship with an outer diameter Dₒᵤₜₜ and an inner diameter Dᵢₙₜ of the torus-shaped diffused target:

Dₒᵤₜₘ≧Dₒᵤₜₜ

Dᵢₙₘ≦Dᵢₙₜ

With this configuration, most of the torus-shaped diffused target may be irradiated by the main pulse laser beam and turned into plasma. The amount of debris generated from the target material may be reduced accordingly.

In the foregoing, the beam intensity distribution, the outer diameter Dₒᵤₜₘ, and the inner diameter Dᵢₙₘ of the main pulse laser beam refer to the beam intensity distribution of the laser beam and the outer and inner diameters of an annular beam intensity distribution, respectively, near the point of irradiation of the diffused target. Although the diffused target is torus-shaped in the above description, the diffused target may be disc-shaped, dish-shaped, or any other diffused target shape. Although in the above description the main pulse laser beam at the point of irradiation of the diffused target has lower beam intensity in its central area than in its periphery, this disclosure is not limited to such a distribution. At the point of irradiation of the diffused target, the main pulse laser beam may have a low intensity region in its central area, the low intensity region extending over a predetermined distance from the beam axis of the laser beam.

### 6. Embodiments of Beam Intensity Distribution Adjusting Optical System

Embodiments of the beam intensity distribution adjusting optical system will now be described. In the following, as exemplary beam intensity distribution adjusting optical systems, two cases are described: one case in which an annular laser beam, i.e., a laser beam with an annular beam intensity distribution on a cross-section perpendicular to the beam axis of the laser beam, is generated and focused by a focusing optical system, and the other case in which the laser beam is symmetrically refracted or reflected and annularly focused by a focusing optical system.

### 6.1 Scheme for Generating Annular Laser Beam and Focusing Annular Laser Beam by Focusing Optical System

### 6.1.1 Generation of Annular Laser Beam by Axicon Lens

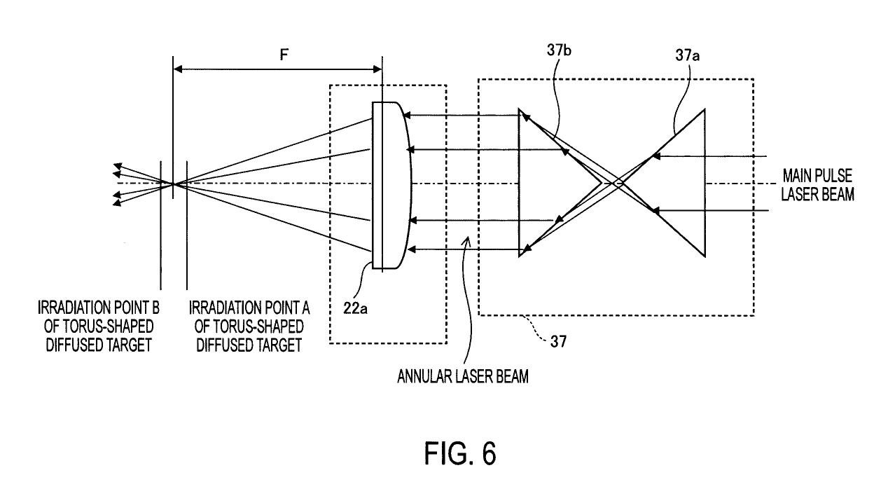

FIG. 6 is a conceptual diagram illustrating a first embodiment of the beam intensity distribution adjusting optical system. The beam intensity distribution adjusting optical system according to the first embodiment may include two axicon lenses 37a and 37b as a laser beam adjusting optical system 37.

The axicon lenses 37a and 37b are conical lenses. The axicon lenses 37a and 37b may be disposed with the lenses' apices facing each other with a predetermined distance therebetween. The axicon lenses 37a and 37b may also be disposed such that their axes of rotational symmetry coincide with the beam axis of the main pulse laser beam. When the main pulse laser beam is incident on the bottom of the axicon lens 37a, an annular laser beam may be output through the bottom of the axicon lens 37b.

The annular laser beam may be focused by the focusing optical system 22a at a focal length F from the principal point of the focusing optical system 22a. At this focal point, the beam intensity is distributed in a Gaussian distribution, for example, in which the beam intensity in its central area is higher than at its periphery. On the other hand, at a plane at either of point A or B, for example, in the periphery of the focal point, the beam intensity is higher in the peripheral area than in the central area. Accordingly, when a torus-shaped diffused target is formed at either of the point A or B, the diffused target may efficiently be irradiated by the main pulse laser beam. In certain embodiments, the focusing optical system for focusing the annular laser beam may comprise a focusing mirror.

### 6.1.2 Generation of Annular Laser Beam by Axicon Mirror

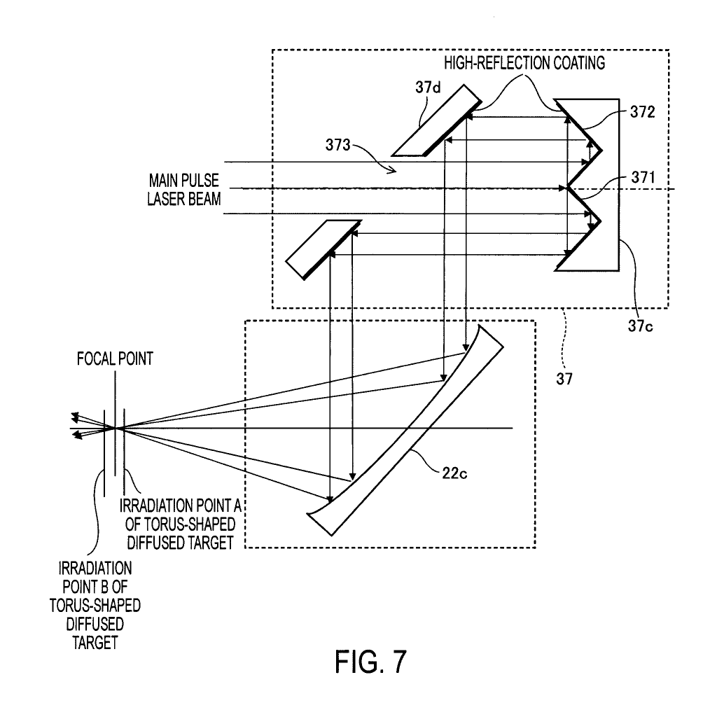

FIG. 7 is a conceptual diagram illustrating a second embodiment of the beam intensity distribution adjusting optical system. The beam intensity distribution adjusting optical system according to the second embodiment may include an axicon mirror 37c and a plane mirror 37d as a laser beam adjusting optical system 37.

The axicon mirror 37c may comprise a double axicon mirror having a first reflective surface 371 with a conical side surface and a second reflective surface 372 coaxially surrounding the first reflective surface 371 and having a side surface in the form of a circular truncated cone. The inclination angle of the first reflective surface 371 with respect to the axis of rotational symmetry and the inclination angle of the second reflective surface 372 with respect to the axis of rotational symmetry may be 45 degrees, respectively. Alternatively, the inclination angle of the first reflective surface 371 with respect to the axis of rotational symmetry and the inclination angle of the second reflective surface 372 with respect to the axis of rotational symmetry may be defined so that the sum of the inclination angles becomes 90 degrees. The axis of rotational symmetry of the axicon mirror 37c may preferably be arranged such that it coincides with the beam axis of the main pulse laser beam. The first reflective surface 371 and the second reflective surface 372 may comprise a high-reflection film that is reflective at the wavelength of the main pulse laser beam.

In certain embodiments, the plane mirror 37d may include a though-hole 373 which may preferably be disposed on the axis of rotational symmetry of the axicon mirror 37c. The plane mirror 37d may preferably be disposed such that the reflective surface thereof faces the reflective surface of the axicon mirror 37c and tilts with respect to the axis of rotational symmetry of the axicon mirror 37c. The reflective surface of the plane mirror 37d may comprise a film that is reflective at the wavelength of the main pulse laser beam.

The main pulse laser beam that passes through the through-hole 373 from the rear side of the reflective surface of the plane mirror 37d may be reflected radially outward by the first reflective surface 371 of the axicon mirror 37c, reflected by the second reflective surface 372 as an annular laser beam again, and then output from the axicon mirror 37c. The annular laser beam reflected by the axicon mirror 37c may be reflected by the reflective surface of the plane mirror 37d toward an off-axis paraboloidal mirror 22c.

The off-axis paraboloidal mirror 22c is a mirror for focusing a parallel incident rays, such as the annular laser beam coming from plane mirror 37d, at a predetermined focal point. The annular laser beam reflected by the plane mirror 37d may be focused by the off-axis paraboloidal mirror 22c and form a focus at the focal point of the off-axis paraboloidal mirror 22c. The beam intensity at this focus may have a Gaussian distribution. In certain embodiments, at the planes of point A or B for example, the beam intensity of the laser beam may be higher in the peripheral area than in the central area. Accordingly, when a torus-shaped diffused target is formed at either of the point A or B, the diffused target may efficiently be irradiated by the main pulse laser beam.

In the second embodiment, the beam intensity distribution adjusting optical system includes reflective optical elements and distortion of the wavefront may be suppressed even if a high-power main pulse laser beam enters the beam intensity distribution adjusting optical system. The focusing optical system for focusing the annular laser beam is not limited to the off-axis paraboloidal mirror 22c but may be a different type of focusing mirror or a focusing lens. The mirror 37d having a through-hole is not limited to the plane mirror 37d but may be a curved mirror such as an off-axis paraboloidal mirror.

### 6.1.3 Generation of Annular Laser Beam by Concentric Diffraction Grating

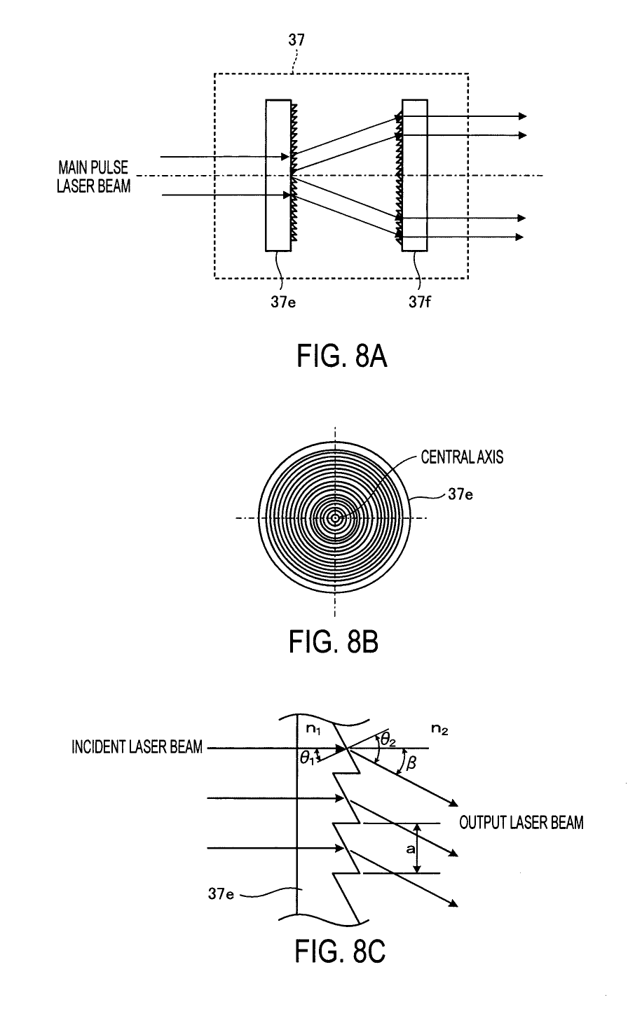

FIG. 8A is a conceptual diagram illustrating a third embodiment of the beam intensity distribution adjusting optical system. The beam intensity distribution adjusting optical system according to the third embodiment may include two diffraction gratings 37e and 37f as a laser beam adjusting optical system 37. FIG. 8B is a view showing a surface with a diffraction grating formed thereon, and FIG. 8C is an enlarged sectional view of the diffraction grating.

As shown in the example embodiment of FIGS. 8A and 8B, the diffraction gratings 37e and 37f may be transmissive diffraction gratings having a plurality of concentric grooves. The diffraction gratings 37e and 37f may preferably be arranged with the grooved surfaces facing each other. The diffraction gratings 37e and 37f may preferably be arranged such that the centers of the concentric circles formed by the grooves of the diffraction gratings 37e and 37f coincide with the beam axis of the main pulse laser beam, with the grooved surfaces being perpendicular to the beam axis. When the laser beam enters the diffraction grating 37e shown in FIG. 8C perpendicularly, i.e. at an angle of incidence of 0 degree, the laser beams diffracted by a plurality of grooves mutually coincide in phase and enhance each other under the condition of equation (2):

mλ=a·sin β (2)

wherein m is the diffraction order, λ is the wavelength of the laser beam, a is the groove pitch, and β is the output angle, as shown in FIG. 8C.

The concentric grooves of the diffraction grating 37e are inclined toward the center of the circle, i.e. each of the grooves having a deeper radially interior portion. Accordingly, the main pulse laser beam transmitted through the diffraction grating 37e are, in this example, output radially outward at the output angle β from the center of the concentric circle. When the main pulse laser beam is incident on the diffraction grating 37e as shown in FIG. 8A, an annular laser beam enlarging in its travelling direction may be output from the diffraction grating 37e and enter the other diffraction grating 37f. The concentric grooves of the diffraction grating 37f may be inclined toward the circumference of the circle. The light at a predetermined wavelength diffracted by these grooves may be incident on the diffraction grating 37f at the incidence angle β and exit the diffraction grating 37f at the output angle of 0 degree. As a result, the light output from the diffraction grating 37f of FIG. 8A may contain an annular laser beam of a certain diameter.

The transmitted laser beam as well as the diffracted laser beam is output from the diffraction gratings 37e and 37f. The grooves of the diffraction grating 37e and 37f are formed with an inclination angle that causes the transmitted laser beam to be inclined at the angle of refraction β and the diffracted laser beam and the transmitted laser beam will coincide with each other and provide a stronger output laser beam. More specifically, the conditions for the angle of refraction of the transmitted laser beam may be given by equation (3):

n₁·sin θ₁=n₂·sin θ₂ (3)

where n₁ is the index of refraction of the diffraction grating, n₂ is the index of refraction of the atmosphere in which the diffraction grating is disposed, θ₁ is the angle of incidence on or output from the diffraction grating and corresponds to the inclination angle of each groove, and θ₂ is the angle of incidence on or output from the atmosphere in which the diffraction grating is disposed.

The angle of refraction β is given by equation (4):

β=|θ₂−θ₁| (4)

By determining the inclination angle θ₁ of the grooves such that the above equations (2) through (4) are satisfied, a strong output laser beam may be obtained.

In this manner, the annular laser beam that is output from the diffraction grating 37f may be focused by the focusing optical system so that the torus-shaped diffused target is irradiated at or near the focal point of the focusing optical system. The focusing optical system may be configured similarly to the focusing optical system in the first or second embodiment.

6.2 Scheme for Refracting or Reflecting Laser Beam Symmetrically with Respect to Optical Axis and Forming Focus by Focusing Optical System
6.2.1 Combination of Axicon Lens with Focusing Optical System

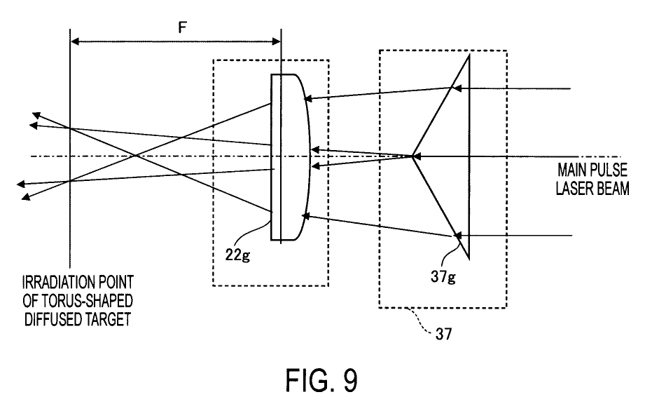

FIG. 9 is a conceptual diagram illustrating a fourth embodiment of the beam intensity distribution adjusting optical system. The beam intensity distribution adjusting optical system according to the fourth embodiment may include an axicon lens 37g as the laser beam adjusting optical system 37 and a focusing optical system 22g as the focusing optical system.

The axicon lens 37g may comprise a conical lens. The axicon lens 37g may preferably be disposed such that its axis of rotational symmetry coincides with the beam axis of the main pulse laser beam. The main pulse laser beam incident on the axicon lens 37g may be refracted symmetrically about the axis of rotational symmetry of the axicon lens 37g and output from the axicon lens 37g at a predetermined angle regardless of the distance from the axis of rotational symmetry.

The laser beam output from the axicon lens 37g may be focused by the focusing optical system 22g at the focal length F from the principal point of the focusing optical system 22g. The beam intensity at this focus may be lower in its central area than in its peripheral area and when a torus-shaped diffused target is formed at this focus, the diffused target may efficiently be irradiated by the main pulse laser beam.

In certain embodiments, the focusing optical system is not limited to the focusing optical system 22g but may be a focusing mirror. Although an axicon convex lens is used as the axicon lens 37g in the above description, comprises an axicon concave lens.

In the fourth embodiment, the annular laser beam may be focused at the focal point of the focusing optical system 22g; thus, the torus-shaped diffused target may be irradiated by an annular laser beam having a sharp contrast in beam intensity.

6.2.2 Combination of Axicon Mirror with Focusing Optical System

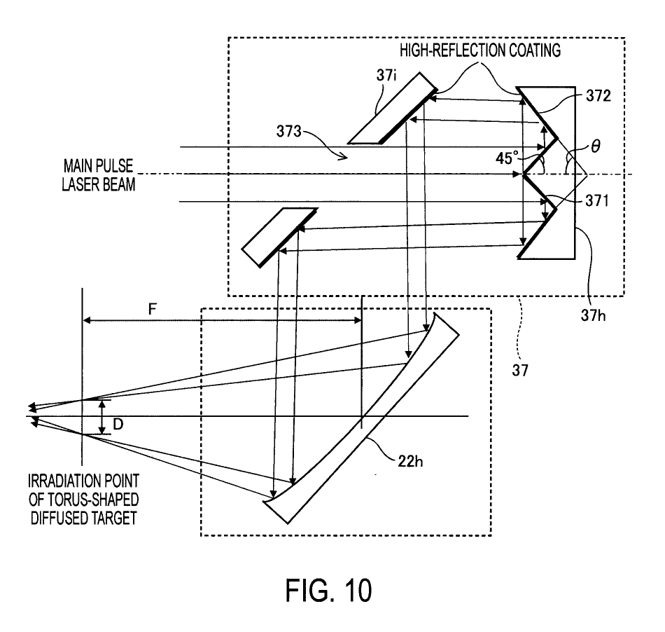

FIG. 10 is a conceptual diagram illustrating a fifth embodiment of the beam intensity distribution adjusting optical system. The beam intensity distribution adjusting optical system according to the fifth embodiment may include an axicon mirror 37h and a plane mirror 37i as the laser beam adjusting optical system 37 and an off-axis paraboloidal mirror 22h as the focusing optical system.

The axicon mirror 37h may be a double axicon mirror similar to the axicon mirror 37c in the second embodiment described with reference to shown in FIG. 7, except in the following. Although the inclination angle of the first reflective surface 371 with respect to the axis of rotational symmetry is 45 degrees, for example, the inclination angle θ of the second reflective surface 372 with respect to the axis of rotational symmetry may be greater than 45 degrees. Thus, the configuration is different from axicon mirror 37c in that the sum of the inclination angle of the first reflective surface 371 with respect to the axis of rotational symmetry and the inclination angle of the second reflective surface 372 with respect to the axis of rotational symmetry is other than 90 degrees.

The configuration and the function of the plane mirror 37i may be similar to those of the plane mirror 37d in FIG. 7.

The main pulse laser beam passing through the through-hole 373 from the rear side of the plane mirror 37i may be reflected by the axicon mirror 37h in the form of an annular laser beam, reflected by the reflective surface of the plane mirror 37i, and focused by the off-axis paraboloidal mirror 22h at the focal point at a distance F from the off-axis paraboloidal mirror 22h. The beam intensity at this focus may be lower in its central area than in its peripheral area. Accordingly, when a torus-shaped diffused target is formed at this focus, the diffused target may efficiently irradiated by the main pulse laser beam.

The diameter D of the region of higher beam intensity at the focus is expressed by equation (5):

D=2F·tan(θ−45°) (5)

where F is the focal length and θ is the inclination angle of the second reflective surface 372 with respect to the axis of rotational symmetry. In the example shown in FIG. 10, the inclination angle of the first reflective surface 371 of the axicon mirror 37h with respect to the axis of rotational symmetry is 45 degrees.

In the fifth embodiment, the beam intensity distribution adjusting optical system includes reflective optical elements, and thus, wavefront distortions may be suppressed even if a high-power main pulse laser beam enters the beam intensity distribution adjusting optical system. In certain embodiments, the focusing optical system comprises a focusing mirror other than an off-axis paraboloidal mirror or a focusing lens. In certain embodiments, the mirror 37i comprises a curved mirror such as an off-axis paraboloidal mirror.

In the fifth embodiment, the annular laser beam may be focused at the focal point of the off-axis paraboloidal mirror 22h, and thus, the torus-shaped diffused target may be irradiated by an annular laser beam having a sharp contrast in beam intensity.

6.2.3 First Combination of Concentric Diffraction Grating with Focusing Optical System

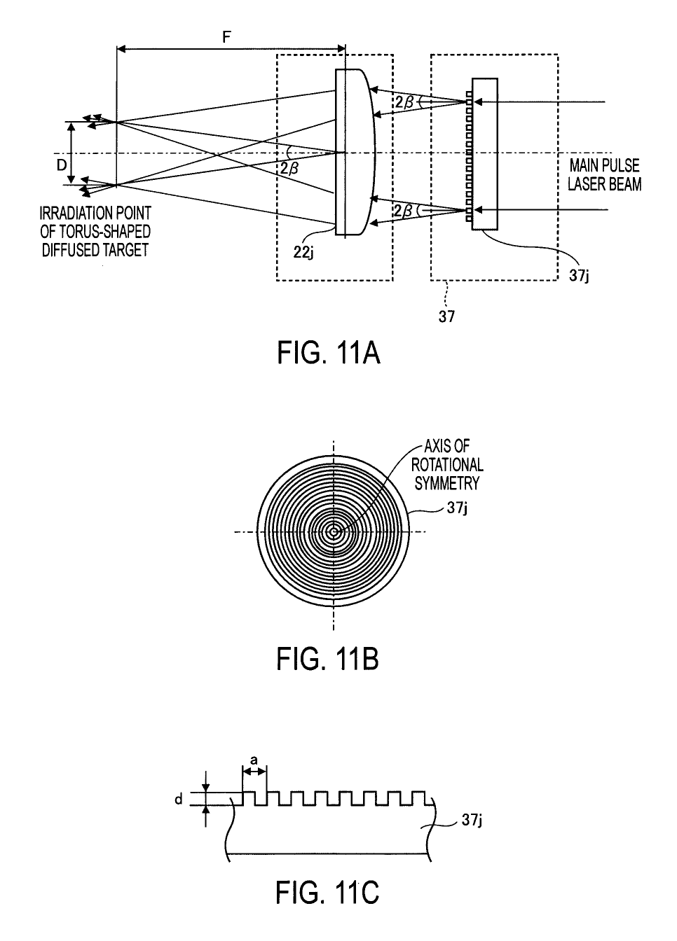

FIG. 11A is a conceptual diagram illustrating a sixth embodiment of the beam intensity distribution adjusting optical system. The beam intensity distribution adjusting optical system according to the sixth embodiment may include a diffraction grating 37j as the laser beam adjusting optical system 37 and a focusing optical system 22j as the focusing optical system. FIG. 11B is a view of the diffraction grating 37j showing the surface on which a diffraction grating is formed. FIG. 11C is an enlarged sectional view of the diffraction grating.

As shown in FIGS. 11A and 11B, the diffraction grating 37j may be a transmissive diffraction grating having a plurality of concentric grooves. The diffraction grating 37j may preferably be disposed such that its axis of rotational symmetry coincides with the beam axis of the main pulse laser beam. As shown in FIG. 11C, the grooves of the diffraction grating 37j may have rectangular sections. The grooves may be formed such that they have a depth d expressed by equation (6):

d=λ/{2(n−1)} (6)

wherein λ is the wavelength of the main pulse laser beam and n is the refraction index of the diffraction grating 37j.

When the laser beam perpendicularly, i.e., at an incidence angle of 0 degree, enters the diffraction grating 37j as shown in FIG. 11A, the laser beams diffracted by a plurality of grooves mutually coincide in phase and intensify each other under the condition of equation (7):

mλ=a·sin β (7)

wherein m is the diffraction order, λ is the wavelength of the laser beam, a is the groove pitch, and β is the output angle. Accordingly, the output angle β is expressed by equation (8):

β=sin⁻¹(mλ/a) (8)

When the groove depth d is set as in the above equation (6), a phase difference π is given between the laser beam transmitted through the grooves and the laser beam transmitted through the ridges, i.e. the portions of the diffraction grating other than the grooves, so that the 0th order diffracted laser beam is weakened. Accordingly, the most intensively diffracted laser beam is the diffracted laser beam of ±1st order.

Since the diffraction grating 37j has a plurality of evenly-spaced concentric grooves, the diffracted laser beams of +1st order and −1st order may be distributed symmetrically about the axis of rotational symmetry and output at a predetermined angle regardless of the distance from the axis of rotational symmetry. Accordingly, when the main pulse laser beam is incident on the diffraction grating 37j as shown in FIG. 11A, the diffracted laser beam of +1st order travelling away from the axis of rotational symmetry and the diffracted laser beam of −1st order travelling toward the axis of rotational symmetry may be output from the diffraction grating 37j.

The laser beam output from the diffraction grating 37j may be focused by the focusing optical system 22j at the focal length F from the principal point of the focusing optical system 22j. The beam intensity at this focus may be lower in its central area than in its peripheral area. Accordingly, when a torus-shaped diffused target is formed at this focus, the diffused target may efficiently be irradiated by the main pulse laser beam.

The diameter D of the central area of higher beam intensity at the focus is expressed by equation (9):

D=2F·tan {sin⁻¹(λ/a)} (9)

wherein F is the focal length of the focusing optical system 22j, λ is the wavelength of the laser beam, and a is the groove pitch.

In certain embodiments, the focusing optical system may comprise a focusing mirror. The diffraction grating 37j is not limited to the transmissive concentric diffraction grating but may be a reflective diffraction grating.

According to the sixth embodiment, the cross-sectional area of the laser beam perpendicular to the beam axis of the laser beam incident on the focusing optical system may be enlarged. Accordingly, the torus-shaped diffused target may be irradiated by an annular laser beam having a sharper contrast in beam intensity than in the fourth embodiment described with reference to FIG. 9.

6.2.4 Second Combination of Concentric Diffraction Grating with Focusing Optical System

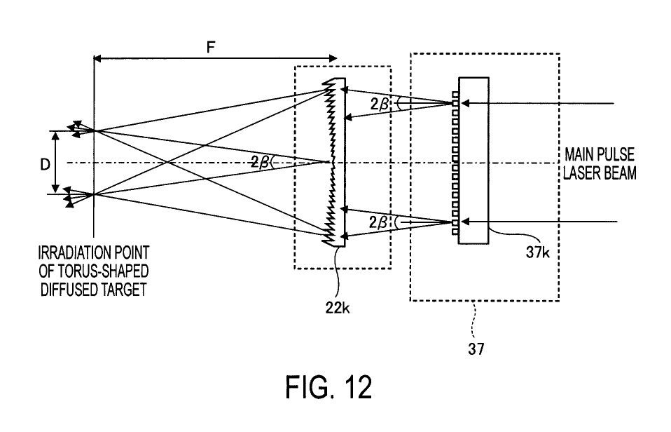

FIG. 12 is a conceptual diagram illustrating a seventh embodiment of the beam intensity distribution adjusting optical system. The beam intensity distribution adjusting optical system according to the seventh embodiment may include a diffraction grating 37k as the laser beam adjusting optical system 37 and a Fresnel lens 22k as the focusing optical system.

The configuration and the function of the diffraction grating 37k may be similar to the configuration and the function of the diffraction grating 37j in the sixth embodiment described with reference to FIGS. 11A through 11C. The Fresnel lens 22k is a spherical lens reduced in thickness and divided into concentric regions with functions similar to the focusing optical system 22j in the sixth embodiment. The diffraction grating 37k and the Fresnel lens 22k may preferably be disposed such that their axes of rotational symmetry coincide with the beam axis of the main pulse laser beam.

When the main pulse laser beam is incident on the diffraction grating 37k, an annular focus is formed at the focal length F from the principal point of the Fresnel lens 22k similarly to the sixth embodiment. Thus, according to the seventh embodiment, a similar effect to that of the sixth embodiment may be obtained.

The above-described embodiments and the modifications thereof are merely examples for implementing this disclosure, and this disclosure is not limited thereto.

The previous description is provided to enable any person skilled in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit this disclosure.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear,” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa.

A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

The terms used in this specification and the appended claims should be interpreted as non-limiting. Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method for generating extreme ultraviolet light, the method comprising the steps of:
(a) supplying a droplet of a target material at an irradiation point;
(b) diffusing the droplet by irradiating the droplet by a pre-pulse laser beam to form a diffused target; and
(c) generating plasma by irradiating the diffused target by a main pulse laser beam and generating extreme ultraviolet light from the plasma, a cross-sectional shape of the main pulse laser beam perpendicular to a beam axis of the main pulse laser beam substantially coinciding with a cross-sectional shape of the diffused target perpendicular to the beam axis of the main pulse laser beam at the irradiation point.

2. The method according to claim 1, wherein the step (b) comprises diffusing the droplet substantially annularly and symmetrically about the beam axis of the main pulse laser beam.

3. The method according to claim 2, wherein the step (c) includes irradiating the diffused target by the main pulse laser beam having lower spatial beam intensity in a central area thereof than in a peripheral area thereof at the irradiation point.

4. A method for generating extreme ultraviolet light, the method comprising the steps of:
(a) supplying a droplet of a target material into a chamber;
(b) irradiating the target material by a pre-pulse laser beam; and
(c) generating plasma by irradiating the target material irradiated by the pre-pulse laser beam by a main pulse laser beam, and generating extreme ultraviolet light from the plasma, the main pulse laser beam having, at an irradiation point of the target material, a low beam intensity region in a central area thereof extending over a predetermined distance from a beam axis of the main pulse laser beam, the low beam intensity region having a first beam intensity that is lower than a second beam intensity in a peripheral area surrounding the central area.

5. An apparatus for generating extreme ultraviolet light, the apparatus comprising:
a chamber comprising an irradiation point;
a target supply unit configured to supply droplets of a target material to the irradiation point;
at least one optical element configured to introduce into the chamber a pre-pulse laser beam for irradiating the target material and a main pulse laser beam for generating plasma by irradiating the target material irradiated by the pre-pulse laser beam, the pre-pulse laser beam comprising a beam intensity and a fluence, the main pulse laser beam comprising a propagation path, a beam axis, a wavefront curvature, and a beam intensity distribution; and
a beam intensity distribution adjusting optical system disposed in the propagation path of the main pulse laser beam, the beam intensity distribution adjusting optical system being configured to adjust the beam intensity distribution of the main pulse laser beam at the irradiation point such that a low beam intensity region extends radially outward around the beam axis of the main pulse laser beam over a predetermined distance and a peripheral region surrounds the low beam intensity region, the low beam intensity region having a first beam intensity and the peripheral region having a second beam intensity that is higher than the first beam intensity.

6. The apparatus according to claim 5, wherein the beam intensity distribution adjusting optical system includes:
a first optical system configured to adjust the main pulse laser beam such that the main pulse laser beam has an annular cross-section perpendicular to the beam axis of the main pulse laser beam; and
a second optical system configured to focus the main pulse laser beam from the first optical system.

7. The apparatus according to claim 6, wherein the beam intensity distribution adjusting optical system includes;
a third optical system configured to refract or reflect the main pulse laser beam at a predetermined angle symmetrically about the beam axis of the main pulse laser beam; and
a fourth optical system configured to focus the main pulse laser beam from the third optical system.

8. The apparatus according to claim 6, wherein the first optical system includes at least one of an axicon lens, an axicon mirror, and a concentric diffraction grating.

9. The apparatus according to claim 7, wherein the third optical system includes at least one of an axicon lens, an axicon mirror, and a concentric diffraction grating.

10. The apparatus according to claim 5, further comprising:
a wavefront adjusting optical system disposed in the propagation path of the main pulse laser beam, the wavefront adjusting optical system configured to adjust the wavefront curvature of the main pulse laser beam; and
a beam combiner configured to coaxialize the main pulse laser beam from the wavefront adjusting optical system with the pre-pulse laser beam.

11. The apparatus according to claim 5, further comprising:
a laser control unit configured to control the beam intensity of the pre-pulse laser beam such that a diffused target is formed from the droplet when irradiated by the pre-pulse laser beam and to control the beam intensity distribution and a generation timing of the main pulse laser beam such that a plasma is generated from the diffused target when irradiated by the main pulse laser beam.

12. The apparatus according to claim 5, further comprising:
a laser control unit configured to control the fluence of the pre-pulse laser beam such that a diffused target is formed from the droplet when irradiated by the pre-pulse laser beam and to control the beam intensity distribution and a generation timing of the main pulse laser beam such that a plasma is generated from the diffused target when irradiated by the main pulse laser beam.

13. The apparatus according to claim 12, wherein the beam intensity distribution adjusting optical system includes:
a first optical system configured to adjust the main pulse laser beam such that the main pulse laser beam has an annular cross-section perpendicular to the beam axis of the main pulse laser beam at the irradiation point; and
a second optical system configured to focus the main pulse laser beam from the first optical system.

14. The apparatus according to claim 13, wherein the beam intensity distribution adjusting optical system includes:
a third optical system configured to refract or reflect the main pulse laser beam at a predetermined angle symmetrically about the beam axis of the main pulse laser beam; and
a fourth optical system configured to focus the main pulse laser beam from the third optical system.

15. The apparatus according to claim 13, wherein the first optical system includes at least one of an axicon lens, an axicon mirror, and a concentric diffraction grating.

16. The apparatus according to claim 14, wherein the third optical system includes at least one of an axicon lens, an axicon mirror, and a concentric diffraction grating.

17. The apparatus according to claim 12, further comprising:
a wavefront adjusting optical system disposed in a laser beam propagation path of the main pulse laser beam, the wavefront adjusting optical system being configured to adjust the wavefront curvature of the main pulse laser beam; and
a beam combiner configured to coaxialize the main pulse laser beam from the wavefront adjusting optical system with the pre-pulse laser beam.
